(19) United States
(12) Patent Application Publication
(10) Pub. No.: US 2026/0132233 A1
(43) Pub. Date: May 14, 2026

(54) RESIN COMPOSITION AND MOLDED PRODUCT

(71) Applicant: AGC Inc., Tokyo (JP)

(72) Inventors: Masatoshi ABE, Tokyo (JP); Toru SASAKI, Tokyo (JP); Yousuke OCHI, Tokyo (JP)

(73) Assignee: AGC Inc., Tokyo (JP)

(21) Appl. No.: 19/429,029

(22) Filed: Dec. 22, 2025

Related U.S. Application Data
(63) Continuation of application No. PCT/JP2024/022970, filed on Jun. 25, 2024.

(30) Foreign Application Priority Data
Jun. 29, 2023 (JP) 2023-106630

(51) Int. Cl. C08F 214/26; C08K 7/06

(52) U.S. Cl. CPC C08F 214/262; C08K 7/06; C08F 2800/10; C08K 2201/003; C08K 2201/004

(57) ABSTRACT

A resin composition having excellent molding workability, with which it is possible to obtain a molded product having excellent mechanical properties and surface smoothness, and a molded product formed of the resin composition. The resin composition includes a melt-moldable fluorine resin and a polyacrylonitrile-based carbon fiber. The polyacrylonitrile-based carbon fiber has a carbon atom content ratio of 90% to 99% by mass, the polyacrylonitrile-based carbon fiber has an average fiber length of 1 mm or less, and the fluorine resin has a mass ratio of 60/40 to 95/5 with respect to the polyacrylonitrile-based carbon fiber.

The present application is a continuation application of International Application No. PCT/JP2024/022970, filed on Jun. 25, 2024, which claims priority of Japanese Patent Application No. 2023-106630 filed on Jun. 29, 2023, the content of which is incorporated herein by reference.

### BACKGROUND OF THE INVENTION

### Field of the Invention

The present invention relates to a resin composition and a molded product.

### Description of Related Art

Fluorine resins have excellent heat resistance, flame retardancy, chemical resistance, atmospheric corrosion resistance, non-stickiness, low friction, low dielectric properties, and the like and are thus used in a wide range of applications, such as corrosion-resistant piping materials in chemical plants, agricultural greenhouse materials, release coating materials for kitchenware, and electrical wire coating materials. However, fluorine resins may be inferior to general engineering plastics in mechanical properties such as tensile strength and flexural strength (Patent Document 1).

Patent Document 1 proposes the following as a resin composition having excellent mechanical properties and with which it is possible to obtain highly elastic molded products.
A resin composition including one or more melt-moldable fluorine resins, and inorganic fibers, in which the ratio of the fluorine resin in 100% by mass total of the fluorine resin and the inorganic fibers is 60% to 95% by mass, the ratio of the inorganic fibers in 100% by mass total of the fluorine resin and the inorganic fibers is 5% to 40% by mass, the inorganic fibers have a sizing agent adhered to at least a portion of the surfaces of the inorganic fibers, and the inorganic fibers have a mass loss rate of 3% or less, as calculated by a specific method.

### RELATED ART DOCUMENT

### Patent Document

[Patent Document 1] PCT International Publication No. WO2023/286801

### SUMMARY OF THE INVENTION

### Technical Problem

However, according to research by the present inventors, the resin composition of Patent Document 1 has room for improvement in molding workability when manufacturing a molded product, in particular, in the surface smoothness of the molded product.

The present invention provides a resin composition having excellent molding workability, with which it is possible to obtain a molded product having excellent mechanical properties and surface smoothness, and a molded product having excellent mechanical properties and surface smoothness.

### Solution to Problem

The present invention has the following aspects.

[1] A resin composition including a melt-moldable fluorine resin, and a polyacrylonitrile-based carbon fiber,
in which the polyacrylonitrile-based carbon fiber has a carbon atom content ratio of 90% by mass or more and less than 99% by mass,
the polyacrylonitrile-based carbon fiber has an average fiber length of 1 mm or less, and
the fluorine resin has a mass ratio of 60/40 to 95/5 with respect to the polyacrylonitrile-based carbon fiber.

[2] The resin composition according to [1], in which the fluorine resin has a unit based on a fluorine-containing monomer, and
the fluorine-containing monomer is at least one selected from the group consisting of a fluoroolefin, a fluorine-containing compound having a ring structure, a compound represented by Formula (1), a compound represented by Formula (2), a compound represented by Formula (3), a compound represented by Formula (4), and a compound represented by Formula (5),

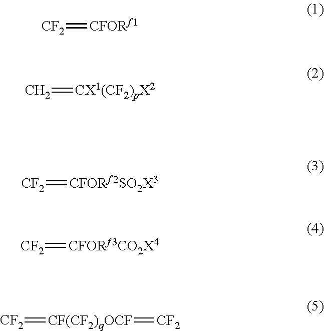

in Formula (1), R^{f1} is a perfluoroalkyl group having 1 to 10 carbon atoms, which may have an etheric oxygen atom between the carbon atoms,
in Formula (2), X¹ is a hydrogen atom or a fluorine atom, p is an integer of 2 to 10, and X² is a hydrogen atom or a fluorine atom,
in Formula (3), R^{f2} is a perfluoroalkylene group having 1 to 10 carbon atoms, which may have an etheric oxygen atom between the carbon atoms, and X³ is a halogen atom or a hydroxyl group,
in Formula (4), R^{f3} is a perfluoroalkylene group having 1 to 10 carbon atoms, which may have an etheric oxygen atom between the carbon atoms, and X⁴ is a hydrogen atom or an alkyl group having 1 to 3 carbon atoms,
in Formula (5), q is 1 or 2.

[3] The resin composition according to [1] or [2], in which the fluorine resin is at least one selected from the group consisting of a copolymer having units based on tetrafluoroethylene and units based on ethylene, a copolymer having units based on chlorotrifluoroethylene and units based on ethylene, a copolymer having units based on tetrafluoroethylene and units based on hexafluoropropylene, a copolymer having units based on tetrafluoroethylene and units based on a compound represented by Formula (1), and a copolymer having units based on tetrafluoroethylene, units based on a compound represented by Formula (2), and units based on ethylene,

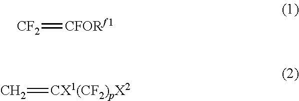

in Formula (1), R^{f1} is a perfluoroalkyl group having 1 to 10 carbon atoms, which may have an etheric oxygen atom between the carbon atoms,
in Formula (2), X¹ is a hydrogen atom or a fluorine atom, p is an integer of 2 to 10, and X² is a hydrogen atom or a fluorine atom.

[4] The resin composition of [3], in which the fluorine resin is at least one selected from the group consisting of the copolymer having units based on tetrafluoroethylene and units based on ethylene, the copolymer having units based on tetrafluoroethylene and units based on the compound represented by Formula (1), and the copolymer having units based on tetrafluoroethylene, units based on the compound represented by Formula (2), and units based on ethylene.

[5] The resin composition of any of [1] to [4], in which the fluorine resin has at least one functional group selected from the group consisting of a carbonyl group-containing group, a hydroxy group, an epoxy group, an amide group, an amino group, and an isocyanate group.

[6] The resin composition of any of [1] to [5], in which the fluorine resin has a melt flow rate of 0.1 to 100 g/10 min.

[7] The resin composition of any of [1] to [6], in which the polyacrylonitrile-based carbon fiber has a carbon atom content ratio of 90% to 98% by mass.

[8] The resin composition of any of [1] to [7], in which the polyacrylonitrile-based carbon fiber has an average fiber diameter of 1 to 20 m.

[9] The resin composition of any of [1] to [8], in which a ratio of the fluorine resin is 50% to 95% by mass of a total amount of the resin composition.

[10] The resin composition of any of [1] to [9], in which a ratio of the polyacrylonitrile-based carbon fiber is 1% to 40% by mass of a total amount of the resin composition.

[11] The resin composition of any of [1] to [10], in which the resin composition has a melt flow rate of 2.5 g/10 min or more at a temperature of 297° C. and a load of 49 N.

[12] The resin composition of any of [1] to [11], in which s, calculated by an equation, is 4.0 or more and less than 6.0,

$$s = t / u$$

in the equation, t is a flexural strength (MPa) of a 4-mm-thick injection-molded product of the resin composition, and u is a content ratio (% by mass) of the polyacrylonitrile-based carbon fiber in a total of the fluorine resin and the polyacrylonitrile-based carbon fiber in the resin composition.

[13]A molded product obtained by molding the resin composition of any of [1] to [12].

[14] The molded product of [13], in which the molded product has a flexural strength of 50 MPa or more.

[15] The molded product of [13] or [14], in which the molded product has a surface roughness of 10 μm or less.

### Effects of the Invention

The resin composition of the present invention has excellent molding workability and makes it possible to obtain molded products having excellent mechanical properties and surface smoothness.

The molded product of the present invention has excellent mechanical properties and surface smoothness.

### DETAILED DESCRIPTION OF THE INVENTION

The meanings of the terms are as follows:

A compound represented by Formula (n) is referred to as “Compound (n)”. n is a natural number.

The term “monomer” means a compound having a polymerizable carbon-carbon double bond.

The term “unit based on a monomer” is a collective term for the atomic group formed directly by the polymerization of a single monomer molecule and the atomic group obtained by chemically converting part of that atomic group. A unit based on a monomer is also referred to simply as a “monomer unit.”

The term “melt-moldable” means exhibiting melt fluidity.

The term “exhibiting melt fluidity” means that there is a temperature at which the melt flow rate is 0.1 to 1,000 g/10 min under conditions of a load of 49 N at a temperature at least 20° C. higher than the melting point of the resin.

The term “etheric oxygen atom” refers to an oxygen atom that forms an ether bond (—O—) between carbon atoms.

The term “melting point” is the temperature corresponding to the maximum value of the melting peak measured by a differential scanning calorimetry (DSC) method.

The term “melt flow rate” is the melt mass-flow rate (MFR) defined in JIS K 7210:1999 (ISO 1133:1997).

“Carbon atom content ratio”, “average fiber length”, and “average fiber diameter” are determined by the methods described in the Examples.

“Surface roughness”, “flexural strength”, and the like are determined by the methods described in the Examples.

“to” indicating a numerical range means that the values denoted before and after “to” are included as the lower limit value and upper limit value. It is possible to optionally combine the lower limit values and upper limit values of the numerical ranges disclosed in the present specification to create new numerical ranges.

### [Resin Composition]

The resin composition of the present invention includes a melt-moldable fluorine resin, and polyacrylonitrile-based carbon fiber (also referred to below as “PAN-based CF”). The carbon atom content ratio of the PAN-based CF is 90% by mass or more and less than 99% by mass and the average fiber length of the PAN-based CF is 1 mm or less. The mass ratio of the fluorine resin with respect to the PAN-based CF is 60/40 to 95/5. A detailed description will be given below of several embodiments.

### (Fluorine Resin)

The fluorine resin is a fluorine-containing polymer having fluorine-containing monomer units and is not particularly limited as long as the fluorine resin is melt-moldable.

The fluorine-containing monomer is not particularly limited as long as the fluorine-containing monomer is a fluorine-containing compound having one polymerizable carbon-carbon double bond. Examples of fluorine-containing monomers include fluoroolefins, fluorine-containing compounds having a ring structure, Compound (1) (also referred to below as “PAVE”), Compound (2) (also referred to below as “FAE”), Compound (3), Compound (4), and Compound (5). However, the fluorine-containing monomer is not limited to these examples. In addition, two or more fluorine-containing monomers may be used in combination.

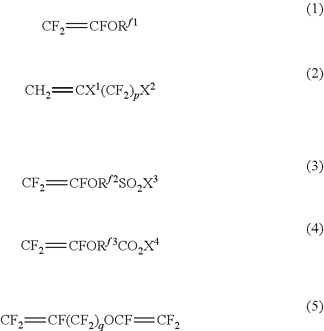

In Formula (1), R^{f1} is a perfluoroalkyl group having 1 to 10 carbon atoms, which may have an etheric oxygen atom between the carbon atoms.

In Formula (2), X¹ is a hydrogen atom or a fluorine atom, p is an integer of 2 to 10, and X² is a hydrogen atom or a fluorine atom.

In Formula (3), R^{f2} is a perfluoroalkylene group having 1 to 10 carbon atoms, which may have an etheric oxygen atom between the carbon atoms, and X³ is a halogen atom or a hydroxyl group.

In Formula (4), R^{f3} is a perfluoroalkylene group having 1 to 10 carbon atoms, which may have an etheric oxygen atom between the carbon atoms, and X⁴ is a hydrogen atom or an alkyl group having 1 to 3 carbon atoms.

In Formula (5), q is 1 or 2.

Examples of fluorine-containing compounds having a ring structure include perfluoro(2,2-dimethyl-1,3-dioxole), 2,2,4-trifluoro-5-trifluoromethoxy-1,3-dioxole, and perfluoro(2-methylene-4-methyl-1,3-dioxolane).

From the viewpoint of mechanical properties, fluoroolefins, PAVE, and FAE are preferable as fluorine-containing monomers, and fluoroolefins and PAVE are more preferable.

Examples of fluoroolefins include tetrafluoroethylene (also referred to below as “TFE”), vinyl fluoride, vinylidene fluoride (also referred to below as “VdF”), trifluoroethylene, chlorotrifluoroethylene (also referred to below as “CTFE”), hexafluoropropylene (also referred to below as “HFP”), and hexafluoroisobutylene. Among the above, from the viewpoints of the moldability and mechanical properties, TFE and HFP are preferable and TFE is more preferable.

Examples of PAVE include CF₂═CFOCF₂CF₃, CF₂=CFOCF₂CF₂CF₃, CF₂=CFOCF₂CF₂CF₂CF₃, and CF₂═CFO(CF₂)₆F. Among the above, CF₂=CFOCF₂CF₂CF₃ (also referred to below as “PPVE”) is preferable from the viewpoint of mechanical properties.

Examples of FAEs include CH₂═CF(CF₂)₂F, CH₂═CF(CF₂)₃F, CH₂═CF(CF₂)₄F, CH₂=CF(CF₂)₅F, CH₂=CF(CF₂)₆F, CH₂=CF(CF₂)₂H, CH₂=CF(CF₂)₃H, CH₂=CF(CF₂)₄H, CH₂=CF(CF₂)₅H, CH₂=CF(CF₂)₆H, CH₂=CH(CF₂)₂F (also referred to below as “PFEE”), CH₂=CH(CF₂)₃F, CH₂=CH(CF₂)₄F (also referred to below as “PFBE”), CH₂=CH(CF₂)₅F, CH₂=CH(CF₂)₆F, CH₂=CH(CF₂)₂H, CH₂=CH(CF₂)₃H, CH₂=CH(CF₂)₄H, CH₂=CH(CF₂)₅H, and CH₂=CH(CF₂)₆H.

Preferably, the FAE is Compound (2-1).

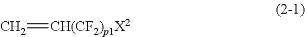

In Formula (2-1), p1 is 2 to 6, preferably 2 to 4, and X² is a hydrogen atom or a fluorine atom.

Preferably, the Compound (2-1) is PFEE, CH₂=CH(CF₂)₃F, PFBE, CH₂=CF(CF₂)₃H, or CH₂=CF(CF₂)₄H, and PFBE and PFEE are more preferable.

The fluorine resin may further have non-fluorine monomer units in addition to fluorine-containing monomer units. The non-fluorine monomer is not particularly limited as long as the non-fluorine monomer is a monomer that does not have a fluorine atom. Examples thereof include olefins such as ethylene, propylene, and 1-butene, vinyl esters such as vinyl acetate, and monomers having a functional group f described below.

When the fluorine resin has non-fluorine monomer units, two or more non-fluorine monomers may be used in combination. From the viewpoint of the excellent mechanical properties and the like of the molded product, ethylene, propylene, and 1-butene are preferable as non-fluorine monomers, and ethylene is particularly preferable.

The fluorine resin may be a homopolymer having fluorine-containing monomer units, a copolymer having two or more fluorine-containing monomer units, or a copolymer having one or more fluorine-containing monomer units and one or more non-fluorine monomer units.

The resin composition may include two or more of these homopolymers or copolymers as the fluorine resin.

When the fluorine resin is a copolymer having fluorine-containing monomer units and non-fluorine monomer units, the ratio of the fluorine-containing monomer units is preferably 40.0 to 99.5 mol % with respect to the total of the fluorine-containing monomer units and non-fluorine monomer units, and more preferably 45 to 99 mol %. When the ratio of the fluorine-containing monomer units is the lower limit value of the above-mentioned numerical ranges or higher, the flame retardancy, chemical resistance, and moldability of the fluorine resin are improved. When the ratio of the fluorine-containing monomer units is the upper limit value of the above-mentioned numerical ranges or lower, the mechanical properties are improved.

Examples of fluorine resins that are homopolymers include polyvinylidene fluoride, polychlorotrifluoroethylene, and polyhexafluoropropylene.

Examples of copolymer fluorine resins include copolymers having TFE units and ethylene units, copolymers having CTFE units and ethylene units, copolymers having TFE units and HFP units, copolymers having TFE units and PAVE units, and copolymers having TFE units, FAE units, and ethylene units.

Among the above, from the viewpoint of mechanical properties and high elasticity, copolymers having TFE units and ethylene units, copolymers having TFE units, FAE units, and ethylene units, and copolymers having TFE units and PAVE units are preferable.

In addition, the fluorine resin is not limited to these examples as long as the fluorine resin is melt-moldable and various other homopolymers and copolymers may also be used.

When the fluorine resin is a copolymer having TFE units and ethylene units, the TFE units are preferably 30 to 70 mol % with respect to all of the monomer units of the copolymer, and more preferably 40 to 60 mol %.

When the fluorine resin is a copolymer having TFE units, FAE units, and ethylene units, preferably, the TFE units are 40 to 64 mol %, the FAE units are 1 to 5 mol %, and the ethylene units are 35 to 59 mol % with respect to all of the monomer units of the copolymer, and, more preferably, the TFE units are 45 to 59 mol %, the FAE units are 1 to 4 mol %, and ethylene units are 40 to 54 mol %.

When the fluorine resin is a copolymer having TFE units and PAVE units, the TFE units are preferably 80.0 to 99.5 mol % with respect to all of the monomer units of the copolymer, and more preferably 90 to 95 mol %.

The melting point of the fluorine resin is preferably 160 to 350° C., more preferably 200 to 320° C., and even more preferably 220 to 280° C. When the melting point of the fluorine resin is the lower limit value of the above-mentioned numerical ranges or higher, the heat resistance is improved. When the melting point of the fluorine resin is the upper limit value of the above-mentioned numerical ranges or lower, it is possible to use general-purpose equipment when producing the molded products. In addition, molded products having excellent mechanical properties are easily obtained.

The melt flow rate of the fluorine resin is preferably 0.1 to 100 g/10 min, more preferably 0.5 to 80 g/10 min, and even more preferably 1 to 50 g/10 min. When the melt flow rate is the lower limit value of the above-mentioned numerical ranges or higher, the fluorine resin has excellent moldability. When the melt flow rate is the upper limit value of the above-mentioned numerical ranges or lower, molded products having excellent mechanical properties are easily obtained.

The fluorine resin may be a fluorine resin (referred to below as “fluorine resin A”) having at least one functional group (referred to below as “functional group f”) selected from the group consisting of a carbonyl group-containing group, a hydroxy group, an epoxy group, an amide group, an amino group, and an isocyanate group. The fluorine resin A may have two or more of the functional group f. The resin composition may include the fluorine resin A and a fluorine resin not having the functional group f.

Since the fluorine resin A has the adhesive functional group f, it is possible to improve the adhesion to PAN-based CF.

From the viewpoint of adhesion to PAN-based CF, the functional group f is preferably present in at least one of the terminal groups of the main chain and pendant groups of the main chain of the fluorine resin A.

From the viewpoint of adhesion to PAN-based CF, the fluorine resin A preferably has at least a carbonyl group-containing group as the functional group f.

Examples of carbonyl group-containing groups include groups having a carbonyl group between carbon atoms in a hydrocarbon group, carbonate groups, carboxy groups, haloformyl groups, alkoxycarbonyl groups, and acid anhydride groups.

In groups having a carbonyl group between carbon atoms in hydrocarbon groups, examples of the hydrocarbon groups include alkylene groups having 2 to 8 carbon atoms. Here, the number of carbon atoms in the alkylene group does not include the carbon atoms forming the carbonyl group. The alkylene group may be linear or may be branched.

A haloformyl group is represented by —C(═O)—X (where X is a halogen atom). Examples of halogen atoms in a haloformyl group include fluorine atoms and chlorine atoms. Among the above, a fluorine atom is preferable. That is, a fluoroformyl group (also known as a carbonyl fluoride group) is preferable as a haloformyl group.

The alkoxy group in an alkoxycarbonyl group may be linear or may be branched. The alkoxy group in an alkoxycarbonyl group is preferably an alkoxy group having 1 to 8 carbon atoms, and methoxy groups and ethoxy groups are particularly preferable.

The content of the functional group f in fluorine resin A is preferably 10 to 60,000 with respect to 1×10⁶ main chain carbon atoms of the fluorine resin A, more preferably 100 to 50,000, even more preferably 100 to 10,000, and particularly preferably 300 to 5,000. When the content of the functional group f is the lower limit value of the above-mentioned numerical ranges or higher, the adhesion to PAN-based CF is further improved. When the content of the functional group f is the upper limit value of the above-mentioned numerical ranges or lower, the adhesion to PAN-based CF is improved even when the melt-molding temperature is lowered.

It is possible to measure the content of the functional group f by methods such as nuclear magnetic resonance (NMR) analysis and infrared absorption spectroscopy. For example, as described in Japanese Unexamined Patent Application, First Publication No. 2007-314720, it is possible to determine the ratio (mol %) of units having the functional group f among all the units forming the fluorine resin A using methods such as infrared absorption spectroscopy and to calculate the content of the functional group f from the ratio (mol %) of the units.

Examples of the fluorine resin A include the following, depending on differences in the production method.

Fluorine resin A1: A fluorine-containing polymer having the functional group f derived from at least one selected from the group consisting of a monomer, a chain transfer agent, and a polymerization initiator used in the production of the polymer (also referred to below as “fluorine-containing polymer A1”).

Fluorine resin A2: A fluorine resin in which the functional group f is introduced into a fluorine resin that does not have the functional group f by a surface treatment such as corona discharge treatment or plasma treatment.

Fluorine resin A3: A fluorine resin obtained by graft polymerization of a monomer having the functional group f onto a fluorine resin that does not have the functional group f.

As the fluorine resin A, the fluorine-containing polymer A1 is preferable for the following reasons.
In the fluorine-containing polymer A1, since the functional group f is present in at least one of the terminal groups of the main chain and the pendant groups of the main chain of the fluorine-containing polymer A1, the adhesion to PAN-based CF is further improved.
The functional group f in the fluorine resin A2 is formed by a surface treatment and is thus unstable and likely to disappear over time.

When the functional group f in the fluorine-containing polymer A1 is derived from the monomer used in the production of the fluorine-containing polymer A1, it is possible to produce the fluorine-containing polymer A1 by the following Method (1). In this case, the functional group f is present in the monomer unit formed by polymerization of the monomer during production.

Method (1): When producing the fluorine-containing polymer A1 by polymerizing a fluorine-containing monomer, a monomer having the functional group f is copolymerized.

When the functional group f in the fluorine-containing polymer A1 is derived from the chain transfer agent used in the production of the fluorine-containing polymer A1, it is possible to produce the fluorine-containing polymer A1 by the following Method (2). In this case, the functional group f is present as a terminal group of the main chain of the fluorine-containing polymer A1.

Method (2): The fluorine-containing polymer A1 is produced by polymerizing a fluorine-containing monomer in the presence of a chain transfer agent having the functional group f.

Examples of chain transfer agents having the functional group f include acetic acid, acetic anhydride, methyl acetate, ethylene glycol, and propylene glycol.

When the functional group f in the fluorine-containing polymer A1 is derived from the polymerization initiator used in the production of the fluorine-containing polymer A1, it is possible to produce the fluorine-containing polymer A1 by the following Method (3). In this case, the functional group f is present as a terminal group of the main chain of the fluorine-containing polymer A1.

Method (3): The fluorine-containing polymer A1 is produced by polymerizing a fluorine-containing monomer in the presence of a polymerization initiator, such as a radical polymerization initiator having the functional group f.

Examples of radical polymerization initiators having the functional group f include di-n-propyl peroxydicarbonate, diisopropyl peroxycarbonate, tert-butyl peroxyisopropyl carbonate, bis(4-tert-butylcyclohexyl) peroxydicarbonate, and di-2-ethylhexyl peroxydicarbonate.

When the functional group f in the fluorine-containing polymer A1 is derived from two or more of the monomers, chain transfer agents, and polymerization initiators used in the production of fluorine-containing polymer A1, it is possible to produce the fluorine-containing polymer A1 by using two or more of the Methods (1) to (3) above in combination.

As the fluorine-containing polymer A1, a fluorine-containing polymer A1 having the functional group f derived from a monomer produced by Method (1) is preferable from the viewpoint of easily controlling the content of the functional group f and easily adjusting the adhesion to PAN-based CF.

As monomers having the functional group f, monomers having a carboxy group, monomers having an acid anhydride group, monomers having a hydroxyl group, and monomers having an epoxy group are preferable. In addition, non-fluorine monomers are preferable as monomers having the functional group f.

Examples of monomers having a carboxy group include maleic acid, itaconic acid, citraconic acid, and undecylenic acid.

Examples of monomers having an acid anhydride group include itaconic anhydride (also referred to below as “IAH”), citraconic anhydride (also referred to below as “CAH”), 5-norbornene-2,3-dicarboxylic anhydride (also referred to below as “NAH”), and maleic anhydride.

Examples of monomers having a hydroxyl group include hydroxybutyl vinyl ether. Examples of monomers having an epoxy group include glycidyl vinyl ether.

However, the monomer having the functional group f is not limited to these examples. In addition, two or more monomers having the functional group f may be used in combination.

As the fluorine-containing polymer A1 having the functional group f derived from a monomer, the following fluorine-containing polymer A11 is particularly preferable from the viewpoint of further improving adhesion to PAN-based CF.

Fluorine-containing polymer A11: A fluorine-containing copolymer having units (also referred to below as “unit u1”) based on TFE or CTFE, units (also referred to below as “unit u2”) based on a cyclic hydrocarbon monomer having an acid anhydride group (also referred to below as “acid anhydride group-containing cyclic hydrocarbon monomer”), and units (also referred to below as “unit u3”) based on a fluorine-containing monomer (excluding TFE and CTFE).

Here, the acid anhydride group in the unit u2 corresponds to the functional group f. Examples of acid anhydride group-containing cyclic hydrocarbon monomers forming the unit u2 include IAH, CAH, NAH, and maleic anhydride. Two or more acid anhydride group-containing cyclic hydrocarbon monomers may be used in combination.

As acid anhydride group-containing cyclic hydrocarbon monomers, IAH, CAH, and NAH are preferable. The use of IAH, CAH, or NAH makes it possible to easily produce the fluorine-containing copolymer A11 having an acid anhydride group without using a special polymerization method required when using maleic anhydride (refer to Japanese Unexamined Patent Application, First Publication No. H11-193312).

As the acid anhydride group-containing cyclic hydrocarbon monomer, IAH and NAH are preferable from the viewpoint of further improving adhesion to PAN-based CF.

Examples of the fluorine-containing monomers forming the unit u3 include fluoroolefins (excluding TFE and CTFE), fluorine-containing compounds having a ring structure, PAVE, FAE, Compound (3), Compound (4), and Compound (5).

Examples of the fluoroolefins, fluorine-containing compounds having a ring structure, PAVE, FAE, Compound (3), Compound (4), and Compound (5) as fluorine-containing monomers forming the unit u3 include the same compounds exemplified above as fluorine-containing monomers forming fluorine resins. The preferable forms thereof are also the same.

As the fluorine-containing monomer forming the unit u3, PAVE and FAE are preferable from the viewpoint of mechanical properties, high elasticity, and moldability.

The preferable ratios of each unit in the fluorine-containing polymer A11 are as follows.

The ratio of the unit u1 is preferably 90 to 99.89 mol %, more preferably 95 to 99.47 mol %, and even more preferably 96 to 98.95 mol %, with respect to the total of the unit u1, the unit u2, and the unit u3.

The ratio of the unit u2 is preferably 0.01 to 3 mol %, more preferably 0.03 to 2 mol %, and even more preferably 0.05 to 1 mol %, with respect to the total of the unit u1, the unit u2, and the unit u3.

The ratio of the unit u3 is preferably 0.1 to 9.99 mol %, more preferably 0.5 to 9.97 mol %, and even more preferably 1 to 9.95 mol %, with respect to the total of the unit u1, the unit u2, and the unit u3.

In addition to the units u1 to u3, the fluorine-containing polymer A11 may further contain units (also referred to below as “unit u4”) based on a non-fluorine monomer (excluding acid anhydride group-containing cyclic hydrocarbon monomers).

The preferable ratios of each unit when the unit u4 is an ethylene unit are as follows.

The ratio of the unit u1 is preferably 25 to 80 mol %, more preferably 40 to 65 mol %, and even more preferably 45 to 63 mol %, with respect to the total of the unit u1, the unit u2, the unit u3, and the unit u4.

The ratio of the unit u2 is preferably 0.01 to 5 mol %, more preferably 0.03 to 3 mol %, and even more preferably 0.05 to 1 mol %, with respect to the total of the unit u1, the unit u2, the unit u3, and the unit u4.

The ratio of the unit u3 is preferably 0.2 to 20 mol %, more preferably 0.5 to 15 mol %, and even more preferably 1 to 12 mol %, with respect to the total of the unit u1, the unit u2, the unit u3, and the unit u4.

The ratio of the unit u4, that is, the ethylene unit, is preferably 20 to 75 mol %, more preferably 35 to 50 mol %, and even more preferably 37 to 55 mol %, with respect to the total of the unit u1, the unit u2, the unit u3, and the unit u4.

When the ratio of the unit u1 is within the above-mentioned numerical ranges, the flame retardancy, chemical resistance, and the like of the molded product are further improved.

When the ratio of the unit u2 is within the above-mentioned numerical ranges, the amount of acid anhydride groups is appropriate, thereby further improving adhesion to PAN-based CF.

When the ratio of the unit u3 is within the above-mentioned numerical ranges, the moldability is further improved.

It is possible to calculate the ratio of each unit by melt NMR analysis, fluorine content analysis, infrared absorption spectroscopy, or the like of the fluorine-containing polymer A11.

The fluorine-containing polymer A11 may include units based on dicarboxylic acid (itaconic acid, citraconic acid, 5-norbornene-2,3-dicarboxylic acid, maleic acid, and the like) corresponding to the acid anhydride group-containing cyclic hydrocarbon monomer, as a result of partial hydrolysis of the acid anhydride group in the unit u2. In this case, the ratio of units based on a dicarboxylic acid corresponding to the acid anhydride group-containing cyclic hydrocarbon monomer is included in the ratio of the unit u2.

Examples of fluorine-containing polymer A11 include copolymers having TFE units, NAH units, and PPVE units, copolymers having TFE units, IAH units, and PPVE units, copolymers having TFE units, CAH units, and PPVE units, copolymers having TFE units, IAH units, and HFP units, copolymers having TFE units, CAH units, and HFP units, copolymers having TFE units, IAH units, PFBE units, and ethylene units, copolymers having TFE units, CAH units, PFBE units, and ethylene units, copolymers having TFE units, IAH units, PFEE units, and ethylene units, copolymers having TFE units, CAH units, PFEE units, and ethylene units, and copolymers having TFE units, IAH units, HFP units, PFBE units, and ethylene units.

It is possible to produce the fluorine resin by conventional methods. For example, it is possible to produce the fluorine resin by polymerizing monomer components including at least a fluorine-containing monomer. The monomer components may further include non-fluorine monomers and monomers having the functional group f, as necessary.

Examples of polymerization methods include bulk polymerization methods, solution polymerization methods using an organic solvent (fluorohydrocarbons, chlorinated hydrocarbons, fluorochlorohydrocarbons, alcohols, hydrocarbons, and the like), suspension polymerization methods using an aqueous medium and, if necessary, an appropriate organic solvent, and emulsion polymerization methods using an aqueous medium and an emulsifier. Among the above, solution polymerization methods are preferable.

### (PAN-Based CF)

The carbon atom content ratio of PAN-based CF is 90% by mass or more and less than 99% by mass. Another type of carbon fiber is pitch-based carbon fiber; however, in the case of pitch-based carbon fiber, insufficient mechanical properties are exhibited if the carbon atom content ratio is 90% by mass or more and less than 99% by mass. With PAN-based CF, excellent mechanical properties are exhibited even when the carbon atom content ratio is 90% by mass or more and less than 99% by mass.

The carbon atom content ratio of the PAN-based CF is not particularly limited, but is preferably 90% to 98% by mass, more preferably 93% to 98% by mass, even more preferably 94% to 97% by mass, and particularly preferably 95% to 96% by mass. When the carbon atom content ratio of PAN-based CF is the lower limit value of the above-mentioned numerical ranges or higher, the strength of the PAN-based CF is easily improved. When the carbon atom content ratio of PAN-based CF is the upper limit value of the above-mentioned numerical ranges or lower, molded products having excellent mechanical properties are easily obtained.

The average fiber length of the PAN-based CF is 1 mm or less. The average fiber length of the PAN-based CF is preferably 0.8 mm or less, more preferably 0.4 mm or less, and even more preferably 0.15 mm or less. When the average fiber length of the PAN-based CF is the above-mentioned upper limit value or less, molded products having excellent surface smoothness are easily obtained.

The lower limit value of the average fiber length of the PAN-based CF is not particularly limited, but may be, for example, 0.01 mm, 0.02 mm, 0.05 mm, or the like.

The average fiber diameter of the PAN-based CF is not particularly limited, but may be, for example, 1 to 20 m, 2 to 15 m, 4 to 10 m, or the like. When the average fiber diameter of the PAN-based CF is the lower limit value of the above-mentioned numerical ranges or higher, molded products having excellent mechanical properties are easily obtained. When the average fiber diameter of the PAN-based CF is the upper limit value of the above-mentioned numerical ranges or lower, dispersibility is improved.

The aspect ratio of the fiber length to the diameter of the PAN-based CF is not particularly limited. The aspect ratio is preferably 2 to 1500, more preferably 5 to 1200, and even more preferably 10 to 100. When the aspect ratio is the lower limit value of the above-mentioned numerical ranges or higher, molded products having excellent mechanical properties are easily obtained. When the aspect ratio is the upper limit value of the above-mentioned numerical ranges or lower, the dispersibility of the PAN-based CF is easily improved.

The cross-sectional shape of the PAN-based CF is not particularly limited. The cross-section of the PAN-based CF may be a circular shape, an elliptical shape, a polygon shape, or an irregular shape. It is possible to appropriately select the cross-sectional shape of the PAN-based CF depending on the desired physical properties.

### (Other Components)

The resin composition may further include components other than the fluorine resin and the PAN-based CF in ranges in which the effects of the invention are not impaired. Examples of other components include inorganic fibers (excluding PAN-based CF), inorganic fillers, metal soaps, surfactants, UV absorbers, lubricants, and silane coupling agents. However, the other components are not limited to these examples.

Examples of inorganic fibers include glass fibers, silicon carbide fibers, silicon nitride fibers, alumina fibers, silicon carbide fibers, boron fibers, and metal fibers. Examples of metal fibers include aluminum fibers, brass fibers, and stainless steel fibers.

### (Composition)

The mass ratio (fluorine resin/PAN-based CF) of the fluorine resin to the PAN-based CF is 60/40 to 95/5. This mass ratio being the lower limit value of the above-mentioned numerical range or higher improves the molding workability of the resin composition. In addition, the surface smoothness of the molded product is improved. This mass ratio being the upper limit value of the above-mentioned numerical range or lower improves the mechanical properties of the molded product. The mass ratio is preferably 65/35 to 90/10, more preferably 70/30 to 90/10, and even more preferably 70/30 to 85/15.

The ratio of the fluorine resin is preferably 50% to 95% by mass of the total amount of the resin composition, more preferably 60% to 90% by mass, and even more preferably 70% to 85% by mass. When the ratio of the fluorine resin is the lower limit value of the above-mentioned numerical ranges or higher, the molding workability of the resin composition is easily improved. In addition, the surface smoothness of the molded product is easily improved. When the ratio of the fluorine resin is the upper limit value of the above-mentioned numerical ranges or lower, the mechanical properties of the molded product are easily improved.

The ratio of the PAN-based CF is preferably 1% to 40% by mass of the total amount of the resin composition, more preferably 10% to 35% by mass, and even more preferably 15% to 30% by mass. When the ratio of PAN-based CF is the lower limit value of the above-mentioned numerical ranges or higher, the mechanical properties of the molded product are easily improved. When the ratio of PAN-based CF is the upper limit value of the above-mentioned numerical ranges or lower, the molding workability of the resin composition is easily improved. In addition, the surface smoothness of the molded product is easily improved.

The total ratio of the fluorine resin and PAN-based CF is preferably 50% to 100% by mass of the total amount of the resin composition, more preferably 60% to 95% by mass, even more preferably 70% to 90% by mass, and may be 100% by mass. When the total ratio of the fluorine resin and PAN-based CF is the lower limit value of the above-mentioned numerical ranges or higher, the molding workability of the resin composition is easily improved. In addition, molded products having excellent mechanical properties and surface smoothness are easily obtained. When the resin composition further includes other components, the properties of the other components are easily imparted when the total ratio of the fluorine resin and the PAN-based CF is the upper limit value of the above-mentioned numerical ranges or lower.

When the resin composition of the present invention further includes other components, the properties of the other components are easily imparted when the ratio of the other components is equal to or more than 1% by mass of the total amount of the resin composition. The ratio of the other components with respect to the resin composition is preferably 10% by mass or less, more preferably 5% by mass or less, and even more preferably 3% by mass or less. When the ratio of the other components is the above-mentioned upper limit value or less, the molding workability of the resin composition is easily improved. In addition, molded products having excellent mechanical properties and surface smoothness are easily obtained.

### (Properties of the Resin Composition)

The melt flow rate of the resin composition at a temperature of 297° C. and a load of 49 N is preferably 2.5 g/10 min or more, more preferably 3 g/10 min or more, and even more preferably 4 g/10 min or more. When the melt flow rate of the resin composition is the above-mentioned lower limit value or more, molded products having excellent surface smoothness are easily obtained. In addition, molding workability is easily improved. The upper limit value of the melt flow rate of the resin composition is not particularly limited, but may be 300 g/10 min, 100 g/10 min, or the like. When the melt flow rate of the resin composition is this upper limit value or less, molded products having excellent mechanical properties are easily obtained.

For the resin composition, s, which is calculated using the following equation (6), is preferably 4.0 or more and less than 6.0, more preferably 4.3 to 5.8, and even more preferably 4.5 to 5.5. When s is the lower limit value of the above-mentioned numerical ranges or higher, molded products having excellent mechanical properties are easily obtained. When s is the upper limit value of the above-mentioned numerical ranges or lower, the effect of improving the mechanical properties is easily obtained with a smaller amount of PAN-based CF. As a result, molded products having excellent mechanical properties and surface smoothness are easily obtained.

$$s = t / u \qquad ( 6 )$$

In equation (6), t is the flexural strength (MPa) of a 4-mm-thick injection-molded product of a resin composition and u is the PAN-based CF content ratio (%) in the total of the fluorine resin and PAN-based CF in the resin composition.

### (Method for Producing Resin Composition)

It is possible to produce the resin composition by melt-kneading the fluorine resin, PAN-based CF, and, if necessary, other components. The resin composition including the melted fluorine resin and PAN-based CF may be extruded into strands and the strands may be cut with a pelletizer to form pellets.

The melt-kneading device is not particularly limited. The melt-kneading device may be provided with a screw that provides a high kneading effect. A single-screw extruder or a twin-screw extruder is preferable, a twin-screw extruder is more preferable, and a twin-screw extruder provided with a screw that provides a high kneading effect is particularly preferable.

It is possible to select a screw with a high kneading effect that exhibits a sufficient kneading effect without applying excessive shear force. Examples of melt-kneading devices include a Labo Plastomill kneader (manufactured by Toyo Seiki Seisaku-sho Ltd.) and a KZW Series twin-screw kneading extruder (manufactured by Technovel Corp.).

As the method for supplying the PAN-based CF to the melt-kneading device, the PAN-based CF may be added to the melt-kneading device either before melt-kneading the fluorine resin or after melt-kneading the fluorine resin. However, from the viewpoint of the mechanical properties, carrying out the addition after melt-kneading the fluorine resin is preferable.

When other components are included in the resin composition, the other components may be added either before melt-kneading the fluorine resin or after melt-kneading the fluorine resin.

The temperature when melt-kneading the fluorine resin is the melting point of the fluorine resin or higher and preferably 5° C. above the melting point of the fluorine resin or higher and 100° C. above the melting point of the fluorine resin or lower.

The extrusion shear rate when melt-kneading the fluorine resin and the residence time of the fluorine resin in the melt-kneading device are not particularly limited and it is possible to appropriately select the conditions depending on the desired application or the like. The extrusion shear rate is preferably set according to the melt viscosity of the fluorine resin at the melt-kneading temperature.

### (Mechanism of Action)

In the resin composition described above, the carbon atom content ratio of the PAN-based CF is 90% by mass or more and less than 99% by mass and the mass ratio of the fluorine resin with respect to the PAN-based CF is 95/5 or less. As a result, the mechanical properties of the molded product are improved.

Additionally, the average fiber length of the PAN-based CF is 1 mm or less and the mass ratio of the fluorine resin with respect to the PAN-based CF is 60/40 or more. As a result, the molding workability of the resin composition is improved and the surface smoothness of the molded product is also improved.

Thus, the resin composition has excellent molding workability. In addition, it is possible to obtain molded products having excellent mechanical properties and surface smoothness.

### (Applications)

It is possible to use the resin composition, for example, as a raw material for molded products. Molded products molded from the resin composition of the present invention have excellent mechanical properties and excellent surface smoothness and are therefore preferably used in applications requiring these properties.

The flexural strength of the molded product is preferably 50 MPa or more, more preferably 65 MPa or more, and even more preferably 80 MPa or more. When the flexural strength of the molded product is the above-mentioned lower limit values or more, the mechanical properties are further improved. The upper limit value of the flexural strength of the molded product is not particularly limited, but may be, for example, 120 MPa or the like.

The surface roughness of the molded product is preferably 10 μm or less, more preferably 5 μm or less, and even more preferably 2 μm or less. When the surface roughness of the molded product is the above-mentioned upper limit values or less, the surface smoothness is further improved. The lower limit value of the surface roughness of the molded product is not particularly limited, but may be, for example, 0.1 μm or the like.

Examples of applications of the molded product are listed below, but these are merely examples and the applications of the molded product are not limited thereto.

Examples of applications of the molded product include housings for portable electronic devices, connecting members for portable electronic devices, sliding members, three-dimensional circuit components, gears, actuators, pistons, bearings, aircraft interior materials, bushings, tubes (for fuel or the like), hoses, tanks, seals, wires, insulating coating materials for electrical wires (wires, cables, or the like), films, sheets, bottles, and fibers. Among the above, portable electronic devices are used while held in the hand and therefore liquids such as oils included in food and cosmetics, beverages, sweat, and sebum easily attach thereto. The molded product of the present invention is resistant to discoloration and deterioration caused by such attachments and is thus suitably used as housings and connecting members for portable electronic devices.

Examples of portable electronic devices include mobile phones, personal digital assistants, laptop computers, tablet computers, radios, cameras, camera accessories, watches, calculators, music players, global positioning system receivers, portable games, hard drives, portable recording devices, portable playback devices, and portable radio receivers.

Examples of the forms of the housing of a portable electronic device include back surface covers, front surface covers, antenna housings, frames, and backbones for portable electronic devices. The housing may be a member formed of a single component of the molded product of the present invention, or a member formed of a plurality of components. Here, the backbone is a member to which portable electronic device components, such as electronics, a microprocessor, a screen, a keyboard, a keypad, an antenna, and a battery socket, are attached.

When the housing is located inside the portable electronic device, the housing may not be visible from the outside of the portable electronic device, or may be partially visible from the outside of the portable electronic device. The housing, such as a cover for protecting and supporting the internal structure, may be exposed to the outside of the portable electronic device.

Examples of the forms of the connecting members of a portable electronic device include snap-on connectors between the circuit board, microphone, speaker, display, battery, cover, electrical connector, electronic connector, hinge, antenna, switch, and switch pad of the portable electronic device. The connecting member is suitable for use in portable electronic devices such as mobile phones, personal digital assistants (PDAs), music storage devices, listening devices, portable DVD players, electric multimeters, portable electronic game consoles, and portable personal computers (for example, notebook computers and the like).

Three-dimensional circuit components are components in which a circuit pattern is formed on the surface of a three-dimensionally molded resin component and are used as antenna components for portable electronic devices and components for in-vehicle electronic devices. As the method for forming a circuit pattern, a laser direct structuring (LDS) method is used, in which the circuit pattern is etched with a laser and then a plating process is performed. The molded product of the present invention has excellent low dielectric properties and is suitable for use in three-dimensional circuit components.

Examples of applications for tubes, hoses, tanks, seals, and wires include the applications described in PCT International Publication No. WO2015/182702. In addition, examples of applications for tubes and hoses include tubes for drilling for energy resources such as petroleum, natural gas, and shale oil. Among the above, tubes for drilling oil are preferable. In addition, preferable applications for tubes also include medical catheters equipped with tubes, electrical wire coatings, and piping for analytical devices.

Examples of applications for electrical wire insulating coating materials include electrical wires or rectangular copper wires for motor coils, particularly, insulating coating materials for rectangular conductors in drive motors for hybrid electric vehicles (HEVs) and electric vehicles (EVs). The insulating coating material for rectangular conductors is preferably in the form of a film. In addition, examples of applications for electrical wire insulating coating materials include insulating coating materials for downhole cables used in drilling for energy resources (oil, natural gas, shale oil, and the like). Among the above, insulating coating materials for downhole cables used in oil drilling are preferable.

Examples of applications for films and sheets include speaker diaphragms, trauma and fracture plates, insulating paper for various electrical insulating adhesive tapes (for example, motor insulating paper) or the like, sealing tape for oil and natural gas pipes or the like, and release films for molding thermosetting and thermoplastic composites. In particular, preferable film applications include speaker diaphragms provided with a film, wire coating films, flexible printed circuit boards, heat-resistant rolls for office equipment, and films for impregnating other fiber composites. The film thickness is preferably 1 to 100 m, more preferably 2 to 80 m, and even more preferably 5 to 50 m. When the film thickness is the lower limit value of the above-mentioned numerical ranges or higher, the film strength is improved. When the film thickness is the upper limit value of the above-mentioned numerical ranges or lower, the film is easy to handle in subsequent steps.

Examples of fiber applications include protective clothing and various filters.

Other examples of applications in the semiconductor industry include members used in manufacturing equipment, attachments, transportation members, and the like. For example, the above may be extrusion-molded articles, injection-molded articles, compression-molded articles, machined products, and the like. Examples thereof include containers, chemical tanks, wafer cases, screws, bolts, nuts, packing, O-rings, valves, fittings, filters, diaphragms, retainer rings, wire coatings, tubes, hoses, joints, piping, coupling members, and duct members. The molded products are also suitably used in magnetic pump components. For example, molded products are used for impellers, casings, split plates, and gaskets.

Examples of molding methods include injection molding methods, extrusion molding methods, coextrusion molding methods, blow molding methods, compression molding methods, transfer molding methods, and film molding methods. However, the molding methods are not limited to these examples.

### EXAMPLES

The following examples are provided to explain the embodiments in more detail. However, the present invention is not limited to the following descriptions. Examples 1 and 2 are Examples and Examples 3 to 7 are Comparative Examples.

### [Measurement Method]

### (Melting Point of Fluorine Resin)

Using a differential scanning calorimeter (DSC device, manufactured by Seiko Instruments Inc.), the melting peak was recorded when the polymer was heated at a rate of 10° C./min and the temperature corresponding to the maximum value was used as the melting point.

### (Melt Flow Rate of Fluorine Resin)

Using a melt indexer (manufactured by Techno Seven Co., Ltd.), the mass of polymer flowing out of a nozzle with a diameter of 2 mm and a length of 8 mm over a 10-minute period was measured under conditions of 297° C. and a load of 49 N.

### (Average Fiber Length of Carbon Fiber)

The lengths of 100 to 300 carbon fibers are measured in a planar photograph taken with an optical microscope at 50× magnification and the average value of these lengths is used as the average fiber length of the carbon fibers. As the carbon fibers for length measurement, carbon fibers positioned diagonally across an observation range of 3000 μm length×5000 μm width are used.

### (Average Fiber Diameter of Carbon Fiber)

In a 50× magnification planar photograph taken with an optical microscope, the widths of 100 to 300 carbon fibers in the planar photograph are measured by assuming the widths to be the diameters and the average value of these widths is used as the average fiber diameter of the carbon fibers. As the carbon fibers for the width (diameter) measurement, carbon fibers positioned diagonally across an observation range of 3000 μm length×5000 μm width are used.

### (Carbon Atom Content Ratio of Carbon Fiber)

The surface composition of the carbon fiber measured by X-ray photoelectron spectroscopy (XPS) is used as the carbon atom content ratio.

### (Carbon Fiber Density)

A value calculated using a method in accordance with JIS R 7603 is used as the density of the carbon fiber.

### (Melt Flow Rate of Resin Composition)

Using a melt indexer (manufactured by Techno Seven Co., Ltd.), the mass of polymer flowing from a nozzle with a diameter of 2.095 mm and a length of 8 mm over a 10-minute period was measured under conditions of 297° C. and a load of 49 N.

### (Preparation of Injection-Molded Products for Evaluation)

Using an injection molding machine (ROBOSHOT α-50C, manufactured by Fanuc Corp.), the resin composition was injection-molded at a mold temperature of 100° C. and a cylinder temperature of 340° C. to obtain injection-molded products for evaluation having a thickness of 4 mm.

### (Surface Roughness)

Test specimens 80 mm in length and 10 mm in width were cut from the injection-molded products for evaluation. The surface roughness (Ra) of the test specimens was measured using a surface roughness measuring device (“Surfcom NEX 100”, manufactured by Tokyo Seimitsu Co., Ltd.). The measurement length was 4 mm.

### (Linear Expansion Coefficient)

The linear expansion coefficient of the injection-molded products for evaluation was measured using a thermomechanical analyzer (SS6100, manufactured by Hitachi High-Tech Science Corp.).

Measurements were performed in both the MD direction and TD direction of the injection molding machine used to prepare the injection-molded products for evaluation.

### (Shrinkage Ratio)

The shrinkage ratio (%) of the injection-molded products for evaluation was calculated using the following equation. Measurements were performed in both the MD direction and TD direction of the injection molding machine used to prepare the injection-molded products for evaluation.

Shrinkage Ratio (%)=((Mold Dimensions−Dimensions of Injection-Molded Product for Evaluation)/(Mold Dimensions))×100.

In this equation, the mold dimension refers to the length of one side of the mold used to prepare the injection-molded products for evaluation and the dimension of the injection-molded products for evaluation refers to the length of one side corresponding to that mold.

### (Bending Test)

Test specimens 80 mm in length and 10 mm in width were cut from the injection-molded products for evaluation. The flexural strength [MPa] and flexural modulus [GPa] of the test specimens were measured using TENSILON (A&D Company, Limited, RTF-1350) in accordance with JIS K7171, with a load cell rating of 1 kN, a support distance of 64 mm, and a rate of 2 mm/min.

### (Izod Impact Strength)

Test specimens 80 mm in length and 10 mm in width were cut from the injection-molded products for evaluation. Notches were made in the injection-molded products for evaluation at a position at a height of 40 mm to obtain test specimens.

The Izod impact strength [J/m] of the test specimens was measured in accordance with ASTM D256 using an Izod testing machine (manufactured by Toyo Seiki Seisaku-sho, Ltd.) under conditions of a hammer capacity of 2.75 J and a distance from the axis to the impact point of 33 cm. The measurements were performed at 23° C.

### (Tensile Test)

The tensile strength [MPa], tensile elongation [%], and tensile modulus [MPa] of the injection-molded products for evaluation were measured in accordance with JIS K7161 using TENSILON (Model: RTF-1350, manufactured by A&D Company, Limited) with a load cell rating of 10 kN, a chuck distance of 115 mm, and a rate of 50 mm/min. The tensile modulus was measured in both the MD direction and the TD direction of the injection molding machine used to prepare the injection-molded products for evaluation.

### [Raw Materials]

### (CF1)

The PAN-based carbon fiber “CF PX30 MF0150” produced by ZOLTEK was used as CF1. The average fiber length, average fiber diameter, carbon atom content ratio, and density of CF1 are shown in Table 1.

### (CF2)

The PAN-based carbon fiber “CF PX35 MF0150” produced by ZOLTEK was used as CF2. The average fiber length, average fiber diameter, carbon atom content ratio, and density of CF2 are shown in Table 1.

### (CF3)

The pitch-based carbon fiber “CF SC-2415” produced by Osaka Gas Co., Ltd., was used as CF3. The average fiber length, average fiber diameter, carbon atom content ratio, and density of CF3 are shown in Table 1.

### (CF4)

The PAN-based carbon fiber “PXCA0250-83” produced by ZOLTEK was used as CF4. The average fiber length, average fiber diameter, carbon atom content ratio, and density of CF4 are shown in Table 1.

### (Fluorine Resin 1)

A fluorine resin 1 not having the functional group f was used. The fluorine resin 1 had TFE units, ethylene units, and PFBE units, in which the TFE units/ethylene units/PFBE units were 54/46/1.4 (molar ratio). The melting point of the fluorine resin 1 was 260° C. and the melt flow rate was 12 g/10 min.

### Examples 1 to 7

To obtain the compositions shown in Table 1, a fluorine resin was introduced into the base end of the screws of a twin-screw extruder (KZW15TW-45MG-NH (−1100), screw diameter: 15 mm, L/D: 45, manufactured by Technovel Corp.) using a feeder, carbon fiber was introduced midway through the twin-screw extruder barrel using a side feeder, the mixture was kneaded at a feed rate of 3 kg/h, a screw speed of 200 rpm, and cylinder, die, and head temperatures of C1=285° C., C2=285° C., C3=285° C., C4=285° C., C5=285° C., C6=285° C., and D=290° C., and the strand extruded from the die tip was collected on a belt conveyor, air-cooled, and cut into pellets using a pelletizer to obtain resin composition pellets. Injection-molded products for evaluation were then obtained. The measurement results for each example are shown in Table 1.

TABLE 1

| | | Example 1 | Example 2 | Example 3 | Example 4 | Example 5 | Example 6 | Example 7 |
|---|---|---|---|---|---|---|---|---|
| Composition | CF1 | — | — | 20 | 15 | 10 | — | — |
| | CF2 | 20 | 10 | — | — | — | — | — |
| | CF3 | — | — | — | — | — | 15 | — |
| | CF4 | — | — | — | — | — | — | 20 |
| | Fluorine | 80 | 90 | 80 | 85 | 90 | 85 | 80 |
| | resin 1 | | | | | | | |
| CF | Type of CF | PAN- | PAN- | PAN- | PAN- | PAN- | PITCH- | PAN- |
| properties | | based | based | based | based | based | based | based |
| | Average | 100 | 100 | 100 | 100 | 100 | 220 | 6000 |
| | fiber length | | | | | | | |
| | of CF [μm] | | | | | | | |
| | Average | 7.2 | 7.2 | 7.2 | 7.2 | 7.2 | 13 | — |
| | fiber | | | | | | | |
| | diameter of | | | | | | | |
| | CF [μm] | | | | | | | |
| | Carbon atom | 95 | 95 | 99 | 99 | 99 | 99 | 99 |
| | content ratio | | | | | | | |
| | of CF | | | | | | | |
| | [mass %] | | | | | | | |
| | Density of | 1.81 | 1.81 | 1.75 | 1.75 | 1.75 | — | 1.80 |
| | CF [g/cc] | | | | | | | |
| Basic | Melt flow | 4.8 | 7.0 | 4.8 | 5.9 | 7.1 | 6.1 | 2.3 |
| physical | rate of resin | | | | | | | |
| properties | composition | | | | | | | |
| | Surface | 0.88 | 0.60 | 0.81 | 0.74 | 0.59 | 0.72 | 21 |
| | roughness | | | | | | | |
| | Ra [μm] | | | | | | | |
| | Linear | 0.0000092 | 0.0000223 | 0.0000232 | 0.0000312 | 0.0000499 | 0.0000329 | — |
| | expansion | | | | | | | |
| | coefficient | | | | | | | |
| | (MD) [/° C.] | | | | | | | |
| | Linear | 0.000135 | 0.000157 | 0.000127 | 0.000108 | 0.000132 | 0.000103 | — |
| | expansion | | | | | | | |
| | coefficient | | | | | | | |
| | (TD) [/° C.] | | | | | | | |
| | Shrinkage | 2.0 | 2.3 | 2.3 | 2.5 | 2.9 | 2.4 | — |
| | ratio (MD) | | | | | | | |
| | [%] | | | | | | | |
| | Shrinkage | 1.8 | 1.6 | 1.5 | 1.3 | 1.2 | 1.0 | — |
| | ratio (TD) | | | | | | | |
| | [%] | | | | | | | |
| Mechanical | Flexural | 90.1 | 53.5 | 64 | 50.6 | 38.5 | 51.2 | 120 |
| properties | strength | | | | | | | |
| | [MPa] | | | | | | | |
| | Flexural | 6216 | 2905 | 4447 | 3095 | 2003 | 2285 | — |
| | modulus | | | | | | | |
| | [MPa] | | | | | | | |
| | Izod impact | 2.89 | 3.26 | 1.24 | 1.51 | 2.11 | 1.29 | — |
| | strength | | | | | | | |
| | [J/m] | | | | | | | |
| | Tensile | 62.8 | 42.5 | 39.5 | 36.3 | 25.7 | 37.1 | 80 |
| | strength | | | | | | | |
| | [MPa] | | | | | | | |
| | Tensile | 12.0 | 23.6 | 11.6 | 18.8 | 51.6 | 13.2 | 5.0 |
| | elongation | | | | | | | |
| | [%] | | | | | | | |
| | Tensile | 3550 | 2429 | 2589 | 2212 | 1774 | 1627 | — |
| | modulus | | | | | | | |
| | [MPa] | | | | | | | |
| | s(t/u) | 4.5 | 5.4 | 3.2 | 3.4 | 3.9 | 3.4 | 6.0 |

In Table 1, CF stands for carbon fiber and s is the value calculated by the equation below.

$$s = t / u$$

In the equation, t is the flexural strength (MPa) of the injection-molded product for evaluation and u is the carbon fiber content ratio (% by mass) of the total of the fluorine resin and the carbon fiber in the resin composition.

In Examples 1 and 2, molded products having lower surface roughness and superior surface smoothness compared to Example 7 were obtained. In addition, the mechanical properties of the molded products in Examples 1 and 2, such as flexural strength, were better than those in Examples 2 to 6.

### INDUSTRIAL APPLICABILITY

The resin composition of the present invention has excellent molding workability and makes it possible to obtain molded products having excellent mechanical properties and surface smoothness. The molded products of the present invention have excellent mechanical properties and surface smoothness.

This application is a continuation application based on Japanese Patent Application No. 2023-106630, filed in Japan on Jun. 29, 2023, the entire contents of which are incorporated herein by reference.

1. A resin composition comprising:
a melt-moldable fluorine resin; and
a polyacrylonitrile-based carbon fiber,
wherein the polyacrylonitrile-based carbon fiber has a carbon atom content ratio of 90% by mass or more and less than 99% by mass,
the polyacrylonitrile-based carbon fiber has an average fiber length of 1 mm or less, and
the fluorine resin has a mass ratio of 60/40 to 95/5 with respect to the polyacrylonitrile-based carbon fiber.

2. The resin composition according to claim 1,
wherein the fluorine resin has a unit based on a fluorine-containing monomer, and
the fluorine-containing monomer is at least one selected from the group consisting of a fluoroolefin, a fluorine-containing compound having a ring structure, a compound represented by Formula (1), a compound represented by Formula (2), a compound represented by Formula (3), a compound represented by Formula (4), and a compound represented by Formula (5), 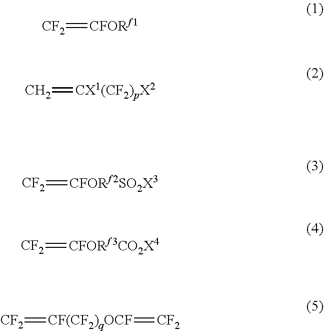
in Formula (1), R^{f1} is a perfluoroalkyl group having 1 to 10 carbon atoms, which may have an etheric oxygen atom between the carbon atoms,
in Formula (2), X¹ is a hydrogen atom or a fluorine atom, p is an integer of 2 to 10, and X² is a hydrogen atom or a fluorine atom,
in Formula (3), R^{f2} is a perfluoroalkylene group having 1 to 10 carbon atoms, which may have an etheric oxygen atom between the carbon atoms, and X³ is a halogen atom or a hydroxyl group,
in Formula (4), R^{f3} is a perfluoroalkylene group having 1 to 10 carbon atoms, which may have an etheric oxygen atom between the carbon atoms, and X⁴ is a hydrogen atom or an alkyl group having 1 to 3 carbon atoms,
in Formula (5), q is 1 or 2.

3. The resin composition according to claim 1,
wherein the fluorine resin is at least one selected from the group consisting of a copolymer having units based on tetrafluoroethylene and units based on ethylene, a copolymer having units based on chlorotrifluoroethylene and units based on ethylene, a copolymer having units based on tetrafluoroethylene and units based on hexafluoropropylene, a copolymer having units based on tetrafluoroethylene and units based on a compound represented by Formula (1), and a copolymer having units based on tetrafluoroethylene, units based on a compound represented by Formula (2), and units based on ethylene, 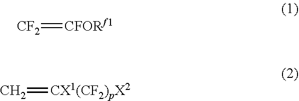
in Formula (1), R^{f1} is a perfluoroalkyl group having 1 to 10 carbon atoms, which may have an etheric oxygen atom between the carbon atoms,
in Formula (2), X¹ is a hydrogen atom or a fluorine atom, p is an integer of 2 to 10, and X² is a hydrogen atom or a fluorine atom.

4. The resin composition according to claim 3,
wherein the fluorine resin is at least one selected from the group consisting of the copolymer having units based on tetrafluoroethylene and units based on ethylene, the copolymer having units based on tetrafluoroethylene and units based on the compound represented by Formula (1), and the copolymer having units based on tetrafluoroethylene, units based on the compound represented by Formula (2), and units based on ethylene.

5. The resin composition according to claim 1,
wherein the fluorine resin has at least one functional group selected from the group consisting of a carbonyl group-containing group, a hydroxy group, an epoxy group, an amide group, an amino group, and an isocyanate group.

6. The resin composition according to claim 1,
wherein the fluorine resin has a melt flow rate of 0.1 to 100 g/10 min.

7. The resin composition according to claim 1,
wherein the polyacrylonitrile-based carbon fiber has a carbon atom content ratio of 90% to 98% by mass.

8. The resin composition according to claim 1,
wherein the polyacrylonitrile-based carbon fiber has an average fiber diameter of 1 to 20 μm.

9. The resin composition according to claim 1,
wherein a ratio of the fluorine resin is 50% to 95% by mass of a total amount of the resin composition.

10. The resin composition according to claim 1,
wherein a ratio of the polyacrylonitrile-based carbon fiber is 1% to 40% by mass of a total amount of the resin composition.

11. The resin composition according to claim 1,
wherein the resin composition has a melt flow rate of 2.5 g/10 min or more at a temperature of 297° C. and a load of 49 N.

12. The resin composition according to claim 1,
wherein s, calculated by an equation, is 4.0 or more and less than 6.0,
$$s = t / u$$
in the equation, t is a flexural strength (MPa) of a 4-mm-thick injection-molded product of the resin composition, and u is a content ratio (% by mass) of the polyacrylonitrile-based carbon fiber in a total of the fluorine resin and the polyacrylonitrile-based carbon fiber in the resin composition.

13. A molded product obtained by molding the resin composition of claim 1.

14. The molded product according to claim 13,
wherein the molded product has a flexural strength of 50 MPa or more.

15. The molded product according to claim 13,
wherein the molded product has a surface roughness of 10 μm or less.
